(19) United States
(12) Patent Application Publication
(10) Pub. No.: US 2015/0036681 A1
(43) Pub. Date: Feb. 5, 2015

(54) PASS-THROUGH ROUTING AT INPUT/OUTPUT NODES OF A CLUSTER SERVER

(71) Applicant: Advanced Micro Devices, Inc., Sunnyvale, CA (US)

(72) Inventors: Sean Lie, Los Gatos, CA (US); Timothy Botsford, Belmont, CA (US); Min Xu, Palo Alto, CA (US)

(73) Assignee: Advanced Micro Devices, Inc., Sunnyvale, CA (US)

(21) Appl. No.: 14/271,600

(22) Filed: May 7, 2014

Related U.S. Application Data
(60) Provisional application No. 61/860,983, filed on Aug. 1, 2013.

(51) Int. Cl. H04L 12/937; H04L 29/08

(52) U.S. Cl. CPC H04L 49/253; H04L 67/2866
USPC 370/359

(57) ABSTRACT

Node locations in the topology of a cluster computer server are designated as input/output (I/O) nodes that provide input and output for the cluster computer server. Examples of I/O nodes include network nodes that provide an interface for the cluster computer server to an external network, and storage nodes that provide access to storage devices for the cluster compute server. The I/O nodes are configured to analyze received messages and identify whether the message is targeted to the receiving I/O node or to another node of the cluster compute server. Those messages targeted to the I/O node are provided to a processing module of the I/O node for processing.

### BACKGROUND

1. Field of the Disclosure

The present disclosure relates generally to processing systems and more particularly to packet switching in a cluster server.

2. Description of the Related Art

High performance computing systems, such as server systems, are sometimes implemented using compute nodes connected together by one or more fabric interconnects. The compute nodes execute software programs to perform designated services, such as file management, database management, document printing management, web page storage and presentation, computer game services, and the like, or a combination thereof. The multiple compute nodes facilitate the processing of relatively large amounts of data while also facilitating straightforward build-up and scaling of the computing system. The fabric interconnects provide a backbone for communication between the compute nodes, and therefore can have a significant impact on processor performance.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a cluster compute server in accordance with some embodiments.

FIG. 2 is a block diagram illustrating an example network topology implemented for a cluster compute server in accordance with some embodiments.

FIG. 3 a block diagram illustrating an example network topology implemented for a cluster compute server showing the location of route-through input/output nodes in accordance with some embodiments.

FIG. 4 is a block diagram illustrating an example physical arrangement of nodes of a cluster compute server in accordance with some embodiments.

FIG. 5 is a block diagram illustrating an example implementation of a compute node of a cluster compute server in accordance with some embodiments.

FIG. 6 is a block diagram illustrating an example implementation of a network node of a cluster compute server in accordance with some embodiments.

FIG. 7 is a block diagram illustrating an example implementation of a storage node of a cluster compute server in accordance with some embodiments.

FIG. 8 is a flow diagram illustrating an example method of routing received packets at a route-through input/output node in a cluster compute server in accordance with some embodiments.

FIG. 9 is a flow diagram illustrating a method for designing and fabricating an integrated circuit (IC) device in accordance with some embodiments.

### DETAILED DESCRIPTION OF EMBODIMENTS

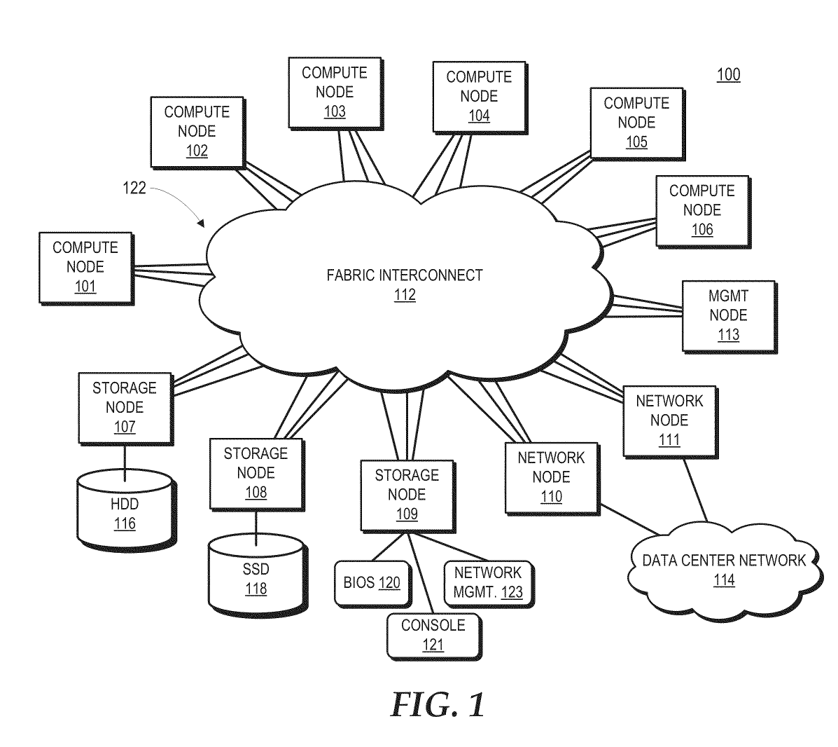

FIGS. 1-9 illustrate example techniques for enhancing communication throughput in a cluster computer server by employing “route-through” input/output nodes that are able to route received packets to connected compute nodes. To illustrate, particular node locations in the topology of the cluster computer server are designated for input/output (I/O) nodes that provide input and output for the cluster computer server. Examples of I/O nodes include network nodes that provide an interface for the cluster computer server to an external network, and storage nodes that provide access to storage devices for the cluster compute server. The I/O nodes are configured to analyze received messages and identify whether the message is targeted to the receiving I/O node or to another node of the cluster compute server. Those messages targeted to the I/O node are provided to a processing module of the I/O node for processing (e.g., processed for communication with the network at a network node, or processed to access a storage device at a storage node). Conventionally, I/O nodes have only been able to receive and process messages targeted to the node, and have not routed messages targeted to compute nodes. This has required messages targeted to compute nodes to be routed around the node locations designated for I/O nodes, reducing communication throughput at the cluster compute server.

In some embodiments, not all of the node locations designated for I/O nodes are used as I/O nodes. In such scenarios, repeater nodes can be inserted at the unused node locations, wherein a repeater node routes received messages to one or more of its connected compute nodes. The repeater node enhances communication throughput at the cluster compute server without requiring each node location to be occupied by a more expensive I/O node that may not be needed for the cluster compute server application.

For ease of illustration, route-through I/O nodes are described in the example context of a cluster compute server as described below with reference to FIGS. 1-7. Examples of such servers include the SM10000 series or the SM15000 series of servers available from the SeaMicro™ division of Advanced Micro Devices, Inc. Although a general description is described below, additional details regarding embodiments of the cluster compute server are found in U.S. Pat. Nos. 7,925,802 and 8,140,719, the entireties of which are incorporated by reference herein. The techniques described herein are not limited to this example context, but instead may be implemented in any of a variety of servers. Moreover, while these techniques are described in the context of an Ethernet implementation employing MAC addresses, these techniques may be implemented in any of a variety of link layer protocols and addressing schemes.

FIG. 1 illustrates a cluster compute server 100 in accordance with some embodiments. The cluster compute server 100, referred to herein as “server 100”, comprises a data center platform that brings together, in a rack unit (RU) system, computation, storage, switching, and server management. The server 100 is based on a parallel array of independent low power compute nodes (e.g., compute nodes 101-106), storage nodes (e.g., storage nodes 107-109), network nodes (e.g., network nodes 110 and 111), and management nodes (e.g., management node 113) linked together by a fabric interconnect 112, which comprises a high-bandwidth, low-latency supercomputer interconnect. Each node is implemented as a separate field replaceable unit (FRU) comprising components disposed at a printed circuit board (PCB)-based card or blade so as to facilitate efficient build-up, scaling, maintenance, repair, and hot swap capabilities.

The compute nodes operate to execute various software programs, including operating systems (OSs), hypervisors, virtualization software, compute applications, and the like. As with conventional server nodes, the compute nodes of the server 100 include one or more processors and system memory to store instructions and data for use by the one or more processors. However, unlike conventional server nodes, in some embodiments the compute nodes do not individually incorporate various local peripherals, such as storage, I/O control, and network interface cards (NICs). Rather, remote peripheral resources of the server 100 are shared among the compute nodes, thereby allowing many of the components typically found on a server motherboard, such as I/O controllers and NICs, to be eliminated from the compute nodes and leaving primarily the one or more processors and the system memory, in addition to a fabric interface device.

The fabric interface device, which may be implemented as, for example, an application-specific integrated circuit (ASIC), operates to virtualize the remote shared peripheral resources of the server 100 such that these remote peripheral resources appear to the OS executing at each processor to be located on corresponding processor's local peripheral bus. These virtualized peripheral resources can include, but are not limited to, mass storage devices, consoles, Ethernet NICs, Fiber Channel NICs, Infiniband™ NICs, storage host bus adapters (HBAs), basic input/output system (BIOS), Universal Serial Bus (USB) devices, Firewire™ devices, PCIe devices, user interface devices (e.g., video, keyboard, and mouse), and the like. This virtualization and sharing of remote peripheral resources in hardware renders the virtualization of the remote peripheral resources transparent to the OS and other local software at the compute nodes. Moreover, this virtualization and sharing of remote peripheral resources via the fabric interface device permits use of the fabric interface device in place of a number of components typically found on the server motherboard. This reduces the number of components implemented at each compute node, which in turn enables the compute nodes to have a smaller form factor while consuming less energy than conventional server blades which implement separate and individual peripheral resources.

The storage nodes and the network nodes (collectively referred to as “input/output (I/O) nodes”) implement a peripheral device controller that manages one or more shared peripheral resources. This controller coordinates with the fabric interface devices of the compute nodes to virtualize and share the peripheral resources managed by the resource manager. To illustrate, the storage node 107 manages a hard disc drive (HDD) 116 and the storage node 108 manages a solid state drive (SSD) 118. In some embodiments, any internal mass storage device can mount any processor. Further, mass storage devices may be logically separated into slices, or “virtual disks”, each of which may be allocated to a single compute node, or, if used in a read-only mode, shared by multiple compute nodes as a large shared data cache. The sharing of a virtual disk enables users to store or update common data, such as operating systems, application software, and cached data, once for the entire server 100. As another example of the shared peripheral resources managed by the I/O nodes, the storage node 109 manages a remote BIOS 120, a console/universal asynchronous receiver-transmitter (UART) 121, and a data center management network 123. The network nodes 110 and 111 each manage one or more Ethernet uplinks connected to a data center network 114. The Ethernet uplinks are analogous to the uplink ports of a top-of rack switch and can be configured to connect directly to, for example, an end-of-row switch or core switch of the data center network 114. The remote BIOS 120 can be virtualized in the same manner as mass storage devices, NICs and other peripheral resources so as to operate as the local BIOS for some or all of the nodes of the server, thereby permitting such nodes to forgo implementation of a local BIOS at each node.

The fabric interface device of the compute nodes, the fabric interfaces of the I/O nodes, and the fabric interconnect 112 together operate as a fabric 122 connecting the computing resources of the compute nodes with the peripheral resources of the I/O nodes. To this end, the fabric 122 implements a distributed switching facility whereby each of the fabric interfaces and fabric interface devices comprises multiple ports connected to bidirectional links of the fabric interconnect 112 and operate as link layer switches to route packet traffic among the ports in accordance with deterministic routing logic implemented at the nodes of the server 100. Note that the term “link layer” generally refers to the data link layer, or layer 2, of the Open System Interconnection (OSI) model.

The fabric interconnect 112 can include a fixed or flexible interconnect such as a backplane, a printed wiring board, a motherboard, cabling or other flexible wiring, or a combination thereof. Moreover, the fabric interconnect 112 can include electrical signaling, photonic signaling, or a combination thereof. In some embodiments, the links of the fabric interconnect 112 comprise high-speed bi-directional serial links implemented in accordance with one or more of a Peripheral Component Interconnect-Express (PCIE) standard, a Rapid IO standard, a Rocket IO standard, a Hyper-Transport standard, a FiberChannel standard, an Ethernet-based standard, such as a Gigabit Ethernet (GbE) Attachment Unit Interface (XAUI) standard, and the like.

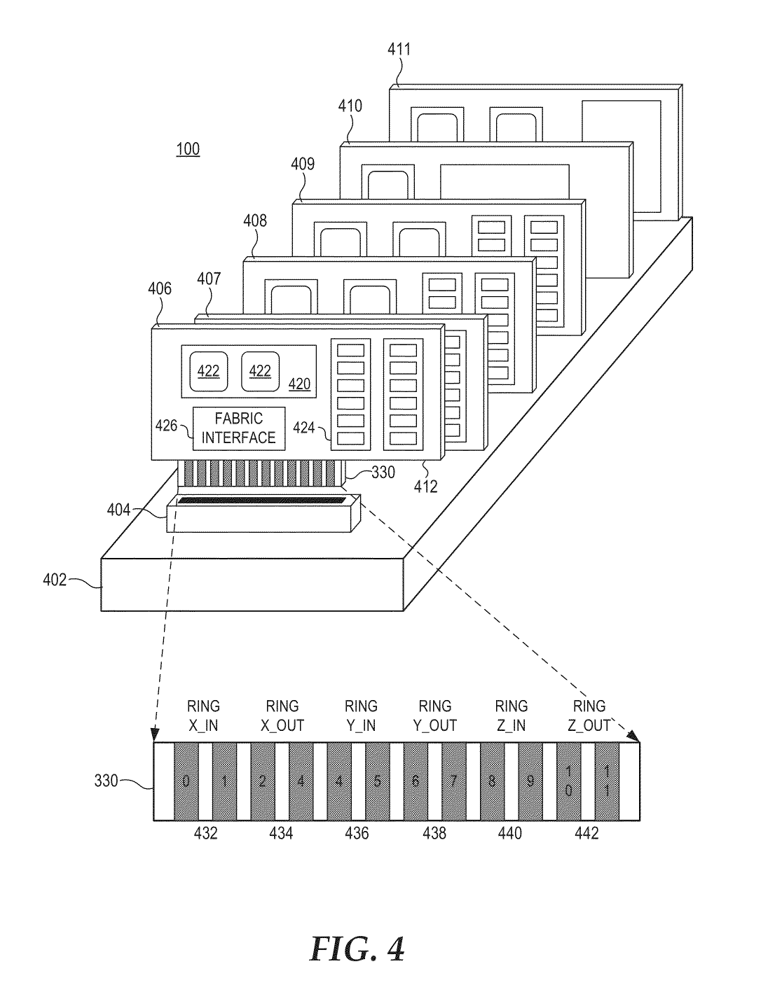

Although the FRUs implementing the nodes typically are physically arranged in one or more rows in a server box as described below with reference to FIG. 4, the fabric 122 can logically arrange the nodes in any of a variety of mesh topologies or other network topologies, such as a torus, a multi-dimensional torus (also referred to as a k-ary n-cube), a tree, a fat tree, and the like. For purposes of illustration, the server 100 is described herein in the context of a multi-dimensional torus network topology. However, the described techniques may be similarly applied in other network topologies using the guidelines provided herein.

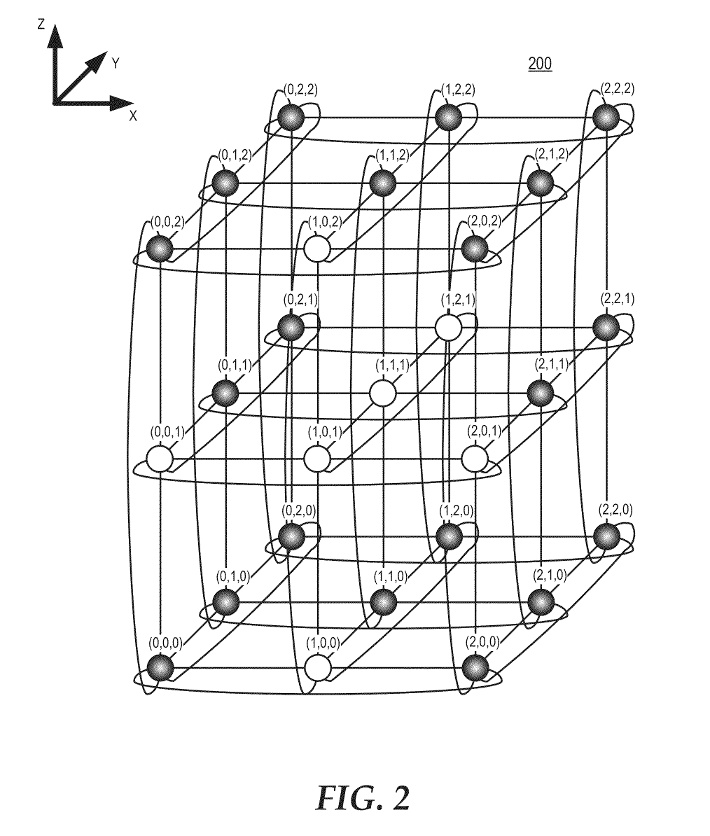

FIG. 2 illustrates an example configuration of the server 100 in a network topology arranged as a k-ary n-cube, or multi-dimensional torus, in accordance with some embodiments. In the depicted example, the server 100 implements a three-dimensional (3D) torus network topology (referred to herein as “torus network 200”) with a depth of three (that is, k=n=3). Accordingly, the server 100 implements a total of twenty-seven nodes arranged in a network of rings formed in three orthogonal dimensions (X,Y,Z), and each node is a member of three different rings, one in each of the dimensions. Each node is connected to up to six neighboring nodes via bidirectional serial links of the fabric interconnect 112 (see FIG. 1). The relative location of each node in the torus network 200 is identified in FIG. 2 by the position tuple (x,y,z), where x, y, and z represent the positions of the compute node in the X, Y, and Z dimensions, respectively. As such, the tuple (x,y,z) of a node also may serve as its address within the torus network 200, and thus serve as source routing control for routing packets to the destination node at the location represented by the position tuple (x,y,z). In some embodiments, one or more media access control (MAC) addresses can be temporarily or permanently associated with a given node. Some or all of such associated MAC address may directly represent the position tuple (x,y,z), which allows the location of a destination node in the torus network 200 to be determined and source routed based on the destination MAC address of the packet. Distributed look-up tables of MAC address to position tuple translations may be cached at the nodes to facilitate the identification of the position of a destination node based on the destination MAC address.

It will be appreciated that the illustrated X, Y, and Z dimensions represent logical dimensions that describe the positions of each node in a network, but do not necessarily represent physical dimensions that indicate the physical placement of each node. For example, the 3D torus network topology for torus network 200 can be implemented via the wiring of the fabric interconnect 112 with the nodes in the network physically arranged in one or more rows on a backplane or in a rack. That is, the relative position of a given node in the torus network 200 is defined by nodes to which it is connected, rather than the physical location of the compute node. In some embodiments, the fabric 122 (see FIG. 1) comprises a plurality of sockets wired together via the fabric interconnect 112 so as to implement the 3D torus network topology, and each of the nodes comprises a field replaceable unit (FRU) configured to couple to the sockets used by the fabric interconnect 112, such that the position of the node in torus network 200 is dictated by the socket into which the FRU is inserted.

In the server 100, messages communicated between nodes are segmented into one or more packets, which are routed over a routing path between the source node and the destination node. The routing path may include zero, one, or more than one intermediate node. As noted above, each node, including each I/O node, includes an interface to the fabric interconnect 112 that implements a link layer switch to route packets among the ports of the node connected to corresponding links of the fabric interconnect 112. In some embodiments, these distributed switches operate to route packets over the fabric 122 using source routing or a source routed scheme, such as a strict deterministic dimensional-order routing scheme (that is, completely traversing the torus network 200 in one dimension before moving to another dimension) that aids in avoiding fabric deadlocks. To illustrate an example of strict deterministic dimensional-order routing, a packet transmitted from the node at location (0,0,0) to location (2,2,2) would, if initially transmitted in the X dimension from node (0,0,0) to node (1,0,0) would continue in the X dimension to node (2,0,0), whereupon it would move in the Y plane from node (2,0,0) to node (2,1,0) and then to node (2,2,0), and then move in the Z plane from node (2,2,0) to node (2,2,1), and then to node (2,2,2). The order in which the planes are completely traversed between source and destination may be preconfigured and may differ for each node.

Moreover, as there are multiple routes between nodes in the torus network 200, the fabric 212 can be programmed for packet traffic to traverse a secondary path in case of a primary path failure. The fabric 212 also can implement packet classes and virtual channels to more effectively utilize the link bandwidth and eliminate packet loops, and thus avoid the need for link-level loop prevention and redundancy protocols such as the spanning tree protocol.

Conventionally, certain types of nodes are limited by design in their routing capabilities. For example, compute nodes are permitted to act as intermediate nodes that exist in the routing path of a packet between the source node of the packet and the destination node of the packet, whereas I/O nodes are configured so as to act as only source nodes or destination nodes, and not as intermediate nodes that route packets to other nodes. In the illustrated embodiment, each I/O node is configured to route packets in a similar fashion to the compute nodes, so that all nodes provide similar routing capability.

Various packet routing and techniques protocols may be implemented by the fabric 122. For example, to avoid the need for large buffers at switch of each node, the fabric 122 may use flow control digit (“flit”)-based switching whereby each packet is segmented into a sequence of flits. The first flit, called the header flit, holds information about the packet's route (namely the destination address) and sets up the routing behavior for all subsequent flit associated with the packet. The header flit is followed by zero or more body flits, containing the actual payload of data. The final flit, called the tail flit, performs some bookkeeping to release allocated resources on the source and destination nodes, as well as on all intermediate nodes in the routing path. These flits then may be routed through the torus network 200 using cut-through routing, which allocates buffers and channel bandwidth on a packet level, or wormhole routing, which allocated buffers and channel bandwidth on a flit level. Wormhole routing has the advantage of enabling the use of virtual channels in the torus network 200. A virtual channel holds the state needed to coordinate the handling of the flits of a packet over a channel, which includes the output channel of the current node for the next hop of the route and the state of the virtual channel (e.g., idle, waiting for resources, or active). The virtual channel may also include pointers to the flits of the packet that are buffered on the current node and the number of flit buffers available on the next node.

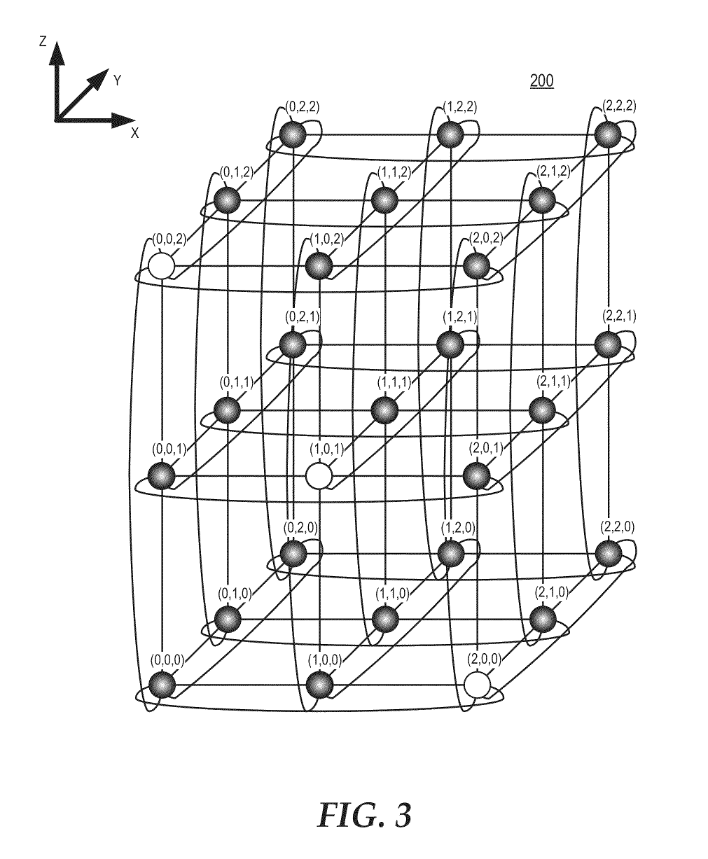

FIG. 3 illustrates an example arrangement of I/O nodes and compute nodes in accordance with some embodiments. The nodes of FIG. 3 are arranged in similar fashion as the nodes of FIG. 2, with locations (2,0,0), (1,0,1), and (0,0,2) being either an I/O node or a repeater node. For example, in some embodiments, location (2,0,0) is a network node, location (1,0,1) is a storage node, and location (0,0,2) is a repeater node.

Repeater nodes are nodes that do not perform any processing to interpret the data of received messages, but simply pass through those messages to one or more of their connected nodes. In some embodiments, the repeater node establishes a one-to-one pass through relationship for each connected node, such that a message received from a given node is always routed to the same connected node. For example, a repeater node at location (0,0,2) can be configured to pass through messages received from node (1,0,2) to node (0,0,1) and to pass through messages received from node (0,0,0) to node (0,1,2). The repeater node is relatively low cost as compared to an I/O node such as a network node or a storage node. Accordingly, a repeater node can be desirable for cluster compute server applications whereby all of the I/O node locations would not be usefully occupied by I/O nodes.

In the illustrated example of FIG. 3, the I/O node locations are arranged on the same plane, defined by the coordinate (x,0,z). Further each I/O node location is offset from the others along at least one other dimension. This configuration can improve communication throughput relative to configurations where the I/O node locations are not offset, or do not share the same plane. In particular, I/O nodes may have a lower communication throughput than compute nodes because of a relatively higher number of messages that are targeted to the I/O nodes themselves. Accordingly, by placing the I/O nodes on the same plane, the routing rules for the cluster compute server can be set up so that most messages are not routed via that plane, improving communication throughput. In addition, by offsetting the I/O nodes in a different dimension, more messages can be routed without using an I/O node in the routing path, further improving communication throughput.

FIG. 4 illustrates an example physical arrangement of nodes of the server 100 in accordance with some embodiments. In the illustrated example, the fabric interconnect 112 (FIG. 1) includes one or more interconnects 402 having one or more rows or other aggregations of plug-in sockets 404. The interconnect 402 can include a fixed or flexible interconnect, such as a backplane, a printed wiring board, a motherboard, cabling or other flexible wiring, or a combination thereof. Moreover, the interconnect 402 can implement electrical signaling, photonic signaling, or a combination thereof. Each plug-in socket 404 comprises a card-edge socket that operates to connect one or more FRUs, such as FRUs 406-311, with the interconnect 402. Each FRU represents a corresponding node of the server 100. For example, FRUs 406-409 may comprise compute nodes, FRU 310 may comprise a network node, and FRU 311 can comprise a storage node.

Each FRU includes components disposed on a PCB, whereby the components are interconnected via metal layers of the PCB and provide the functionality of the node represented by the FRU. For example, the FRU 406, being a compute node in this example, includes a PCB 312 implementing a processor 420 comprising one or more processor cores 422, one or more memory modules 424, such as DRAM dual inline memory modules (DIMMs), and a fabric interface device 426. Each FRU further includes a socket interface 440 that operates to connect the FRU to the interconnect 402 via the plug-in socket 404.

The interconnect 402 provides data communication paths between the plug-in sockets 404, such that the interconnect 402 operates to connect FRUs into rings and to connect the rings into a 2D- or 3D-torus network topology, such as the torus network 300 of FIG. 3. The FRUs take advantage of these data communication paths through their corresponding fabric interfaces, such as the fabric interface device 326 of the FRU 306.

The socket interface 430 provides electrical contacts (e.g., card edge pins) that electrically connect to corresponding electrical contacts of plug-in socket 404 to act as port interfaces for an X-dimension ring (e.g., ring-X_IN port 332 for pins 0 and 1 and ring-X_OUT port 334 for pins 2 and 3), for a Y-dimension ring (e.g., ring-Y_IN port 336 for pins 4 and 5 and ring-Y_OUT port 338 for pins 6 and 7), and for an Z-dimension ring (e.g., ring-Z_IN port 340 for pins 8 and 9 and ring-Z_OUT port 342 for pins 10 and 11). In the illustrated example, each port is a differential transmitter comprising either an input port or an output port of, for example, a PCIE lane. A skilled artisan will understand that a port can include additional TX/RX signal pins to accommodate additional lanes or additional ports.

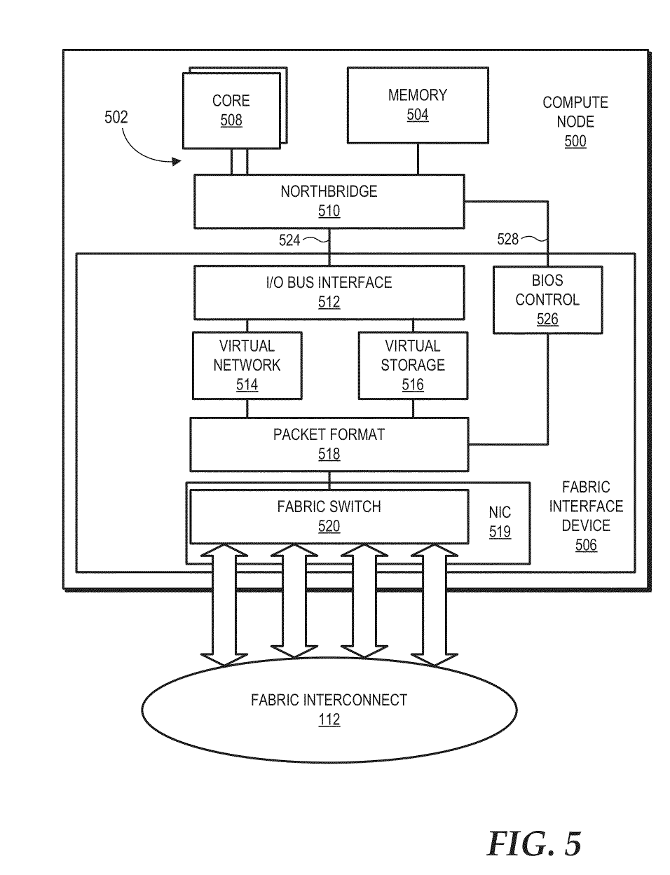

FIG. 5 illustrates a compute node 500 implemented in the server 100 of FIG. 1 in accordance with some embodiments. The compute node 500 corresponds to, for example, one of the compute nodes 101-106 of FIG. 1. In the depicted example, the compute node 500 includes a processor 502, system memory 504, and a fabric interface device 506 (representing the processor 420, the one or more memory modules 424, and the fabric interface device 426, respectively, of FIG. 3). The processor 502 includes one or more processor cores 508 and a northbridge 510. The one or more processor cores 508 can include any of a variety of types of processor cores, or combination thereof, such as a central processing unit (CPU) core, a graphics processing unit (GPU) core, a digital signal processing unit (DSP) core, and the like, and may implement any of a variety of instruction set architectures, such as an x86 instruction set architecture or an Advanced RISC Machine (ARM) architecture. The system memory 504 can include one or more memory modules, such as DRAM modules, SRAM modules, flash memory, or a combination thereof. The northbridge 510 interconnects the one or more cores 508, the system memory 504, and the fabric interface device 506. The fabric interface device 506, in some embodiments, is implemented in an integrated circuit device, such as an application-specific integrated circuit (ASIC), a field-programmable gate array (FPGA), mask-programmable gate arrays, programmable logic, and the like.

In a conventional computing system, the northbridge 510 would be connected to a southbridge, which would then operate as the interface between the northbridge 510 (and thus the processor cores 508) and one or local more I/O controllers that manage local peripheral resources. However, as noted above, in some embodiments the compute node 500 does not maintain local peripheral resources or their UO controllers, and instead uses shared remote peripheral resources at other nodes in the server 100. To render this arrangement transparent to software executing at the processor 502, the fabric interface device 406 virtualizes the remote peripheral resources allocated to the compute node such that the hardware of the fabric interface device 506 emulates a southbridge and thus appears to the northbridge 510 as a local southbridge connected to local peripheral resources.

To this end, the fabric interface device 506 includes an I/O bus interface 512, a virtual network controller 514, a virtual storage controller 516, a packet formatter 518, and a NIC 519 comprising a fabric switch 520. The I/O bus interface 512 connects to the northbridge 510 via a local I/O bus 524 and acts as a virtual endpoint for each local processor core 508 by intercepting requests addressed to virtualized peripheral resources that appear to be on the local I/O bus 524 and responding to the requests in the same manner as a local peripheral resource, although with a potentially longer delay due to the remote location of the peripheral resource being virtually represented by the I/O bus interface 512.

While the I/O bus interface 512 provides the physical interface to the northbridge 510, the higher-level responses are generated by the virtual network controller 514 and by the virtual storage controller 516. Requests sent over I/O bus 524 for a network peripheral connected to an external network, such as an Ethernet NIC connected to the data center network 114 (FIG. 1), are routed by the I/O bus interface 412 to the virtual network controller 514, while storage requests are routed by the I/O bus interface 512 to the virtual storage controller 516. The virtual network controller 514 provides processing of incoming and outgoing requests based on, for example, an Ethernet protocol. The virtual storage controller provides processing of incoming and outgoing requests based on, for example, a serial ATA (SATA) protocol, a serial attached SCSI (SAS) protocol, a Universal Serial Bus (USB) protocol, and the like.

After being processed by either the virtual network controller 514 or the virtual storage controller 516, requests are forwarded to the packet formatter 518, which encapsulates the request into one or more packets. The packet formatter 518 then determines the fabric address or other location identifier of the I/O node managing the physical peripheral resource intended for the request. The packet formatter 518 adds the identified fabric address (referred to herein as the “fabric ID”) to the headers of the one or more packets in which the request is encapsulated and provides the packets to the fabric switch 520 of the NIC 519 for transmission.

As illustrated, the fabric switch 520 implements a plurality of ports, each port interfacing with a different link of the fabric interconnect 112. To illustrate using the 3×3 torus network 200 of FIG. 2, assume the compute node 500 represents the node at (1,1,1). In this example, the fabric switch 520 would have at least seven ports to couple it to seven bi-directional links: an internal link to the packet formatter 518; an external link to the node at (0,1,1); an external link to the node at (1,0,1), an external link to the node at (1,1,0), an external link to the node at (1,2,1), an external link to the node at (2,1,1), and an external link to the node at (1,1,2). Control of the switching of data among the ports of the fabric switch 520 is determined based on integrated deterministic switching logic, which specifies the egress port based on the destination address (that is, destination fabric ID) indicated by the packet and based on the deterministic routing implemented in the server 100.

For responses to outgoing requests and other incoming requests (e.g., requests from other compute nodes or from I/O nodes), the process described above is reversed. The fabric switch 520 receives an incoming packet and routes the incoming packet to the port connected to the packet formatter 518 based on the deterministic routing logic. The packet formatter 518 then deencapsulates the response/request from the packet and provides it to either the virtual network controller 514 or the virtual storage controller 516 based on a type-identifier included in the request. The controller receiving the request then processes the response/request and controls the I/O bus interface 512 to signal the request to the northbridge 510, whereupon the response/request is processed as though it were a response or request from a local peripheral resource.

For a transitory packet for which the compute node 500 is an intermediate node in the routing path for the packet, the fabric switch 520 determines the destination address (e.g., the tuple (x,y,z)) from the header of the transitory packet, and provides the packet to a corresponding output port identified by the deterministic routing logic.

As noted above, the BIOS likewise can be a virtualized peripheral resource. In such instances, the fabric interface device 506 can include a BIOS controller 526 connected to the northbridge 510 either through the local I/O bus 524 or via a separate low pin count (LPC) bus 528. As with storage and network resources, the BIOS controller 526 can emulate a local BIOS by responding to BIOS requests from the northbridge 510 by forwarding the BIOS requests via the packet formatter 518 and the fabric switch 520 to a I/O node managing a remote BIOS, and then providing the BIOS data supplied in turn to the northbridge 510.

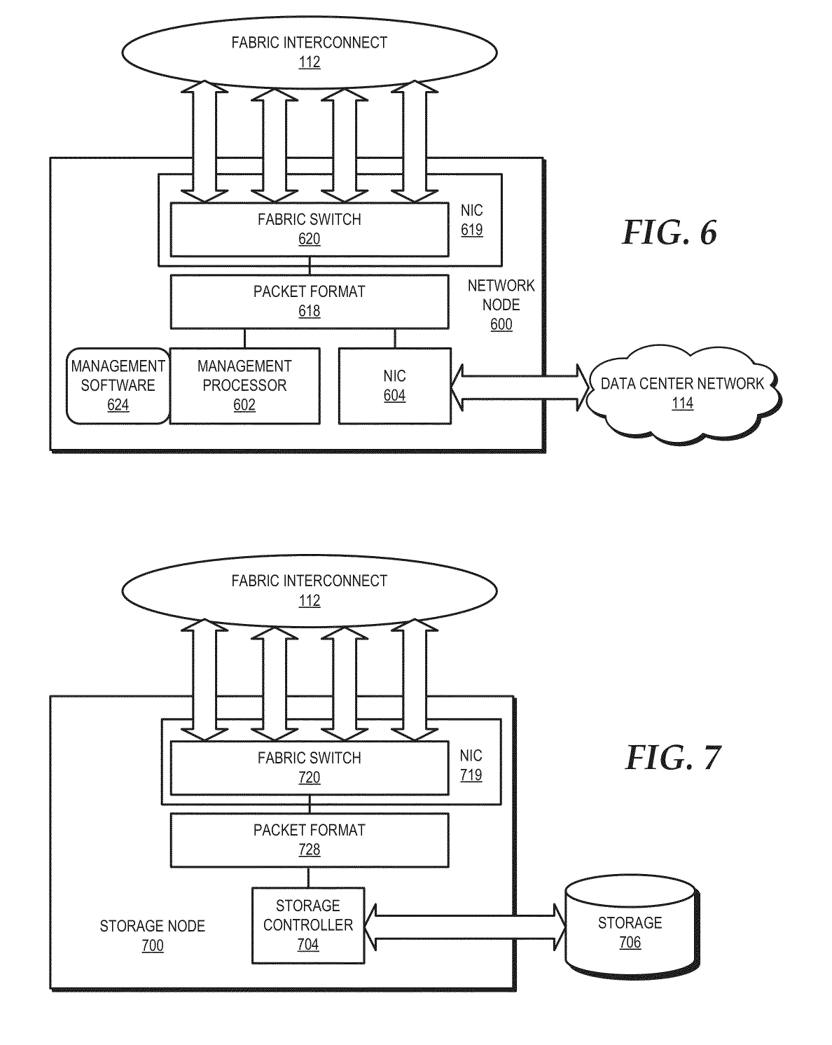

FIG. 6 illustrates a network node 600 implemented in the server 100 of FIG. 1 in accordance with some embodiments. The network node 600 corresponds to, for example, network nodes 110 and 111 of FIG. 1. In the depicted example, the network node 600 includes a management processor 602, an uplink NIC 604 connected to, for example, an external Ethernet network such as the data center network 114, a packet formatter 618, and a fabric-side NIC 619, which includes a fabric switch 620. As with the fabric switch 520 of FIG. 5, the fabric switch 620 operates to switch incoming and outgoing packets among its plurality of ports based on a local distributed routing table 622. The packet formatter 618 may employ a local translation cache 642 to enable non-SRC MAC address to SRC MAC address translation as described above and as described in greater detail below.

A packetized incoming request targeted to the uplink NIC 604 (which is virtualized to appear to the processor 502 of a compute node 500 as a local NIC) is intercepted by the fabric switch 620 from the fabric interconnect 112 and routed to the packet formatter 618, which de-encapsulates the packet and forwards the request to the uplink NIC 604. The uplink NIC 604 then performs the one or more operations dictated by the request. Conversely, outgoing messages from the uplink NIC 604 are encapsulated by the packet formatter 618 into one or more packets, and the packet formatter 618 determines the destination address and inserts the destination address into the header of the outgoing packets. The outgoing packets are then switched to the port associated with the link in the fabric interconnect 112 connected to the next node in the source routed path between the network node 600 and the intended destination node.

The management processor 602 executes management software 624 stored in a local storage device (e.g., firmware ROM or flash memory) to provide various management functions for the server 100. These management functions can include maintaining a centralized master link layer address translation table and distributing portions thereof to the local translation caches of individual nodes. Further, the management functions can include link aggregation techniques, such implementation of IEEE 802.3ad link aggregation, and media access control (MAC) aggregation and hiding.

FIG. 7 illustrates a storage node 700 implemented in the server 100 of FIG. 1 in accordance with some embodiments. The storage node 700 corresponds to, for example, storage nodes 107-109 of FIG. 1. As illustrated, the storage node 700 is configured similar to the network node 600 of FIG. 6 and includes a NIC 719 having a fabric switch 720, a packet formatter 718, and a local translation cache 742, which operate in the manner described above with reference to the fabric switch 620, the packet formatter 618, and the local translation cache 642 of the network node 600 of FIG. 6. However, rather than implementing a NIC, the storage node 700 implements a storage device controller 704, such as a SATA controller. A depacketized incoming request is provided to the storage device controller 704, which then performs the operations represented by the request with respect to a mass storage device 706 or other peripheral device (e.g., a USB-based device). Data and other responses from the peripheral device are processed by the storage device controller 704, which then provides a processed response to the packet formatter 718 for packetization and transmission by the fabric switch 720 to the destination node via the fabric interconnect 112.

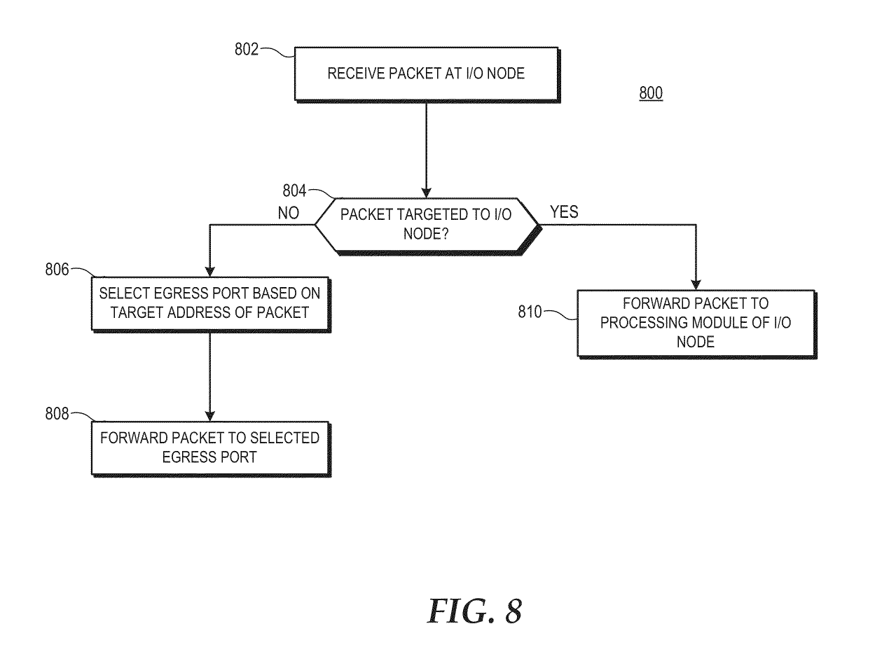

FIG. 8 illustrates a method 800 of routing received packets at a route-through input/output node in a cluster compute server in accordance with some embodiments. At block 802, the I/O node receives a packet from another node of the cluster compute server. At block 804 the I/O node determines the destination address (e.g., the tuple (x,y,z)) from the header of the received packet. If the destination address indicates that the packet is targeted to a node other than the I/O node, the method flow proceeds to block 806 and the I/O node selects, based on the destination address, an egress port of the I/O node. At block 808, the L/O node forwards the packet to the selected egress port, thereby routing the packet through the I/O node.

Returning to block 804, if the I/O node determines that the destination address indicates the I/O node is itself the destination for the packet, the method flow moves to block 810 and the I/O node forwards the packet to a processing module of the node. For example, if the I/O node is a network node, it provides the packet to one or more of the management processor or network interface card of the network node for processing. If the I/O node is a storage node, it provides the packet to the storage controller for processing.

In some embodiments, at least some of the functionality described above may be implemented by one or more processors executing one or more software programs tangibly stored at a computer readable medium, and whereby the one or more software programs comprise instructions that, when executed, manipulate the one or more processors to perform one or more functions described above. In some embodiments, the apparatus and techniques described above are implemented in a system comprising one or more integrated circuit (IC) devices (also referred to as integrated circuit packages or microchips), such as certain components of the server 100 (e.g., the fabric interface device or the compute node) described above with reference to FIGS. 1-8. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

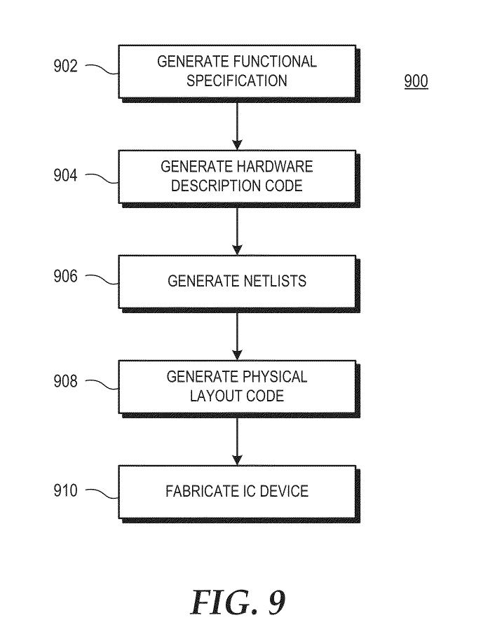

FIG. 9 is a flow diagram illustrating an example method 1000 for the design and fabrication of an IC device implementing one or more aspects. As noted above, the code generated for each of the following processes is stored or otherwise embodied in computer readable storage media for access and use by the corresponding design tool or fabrication tool.

At block 902 a functional specification for the IC device is generated. The functional specification (often referred to as a micro architecture specification (MAS)) may be represented by any of a variety of programming languages or modeling languages, including C, C++, SystemC, Simulink™, or MATLAB™.

At block 904, the functional specification is used to generate hardware description code representative of the hardware of the IC device. In at some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 1006 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 908, one or more EDA tools use the netlists produced at block 906 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 910, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A server system, comprising:
a fabric interconnect to route messages;
a plurality of compute nodes coupled to the fabric interconnect to execute services for the server system, each of the plurality of compute nodes to route received messages to others of the plurality of compute nodes; and
a first input/output (I/O) node coupled to the fabric interconnect to send and receive data for the plurality of compute nodes and to route a first message received from a first compute node of the plurality of compute nodes to a second compute node of the plurality of compute nodes.

2. The server system of claim 1, wherein the first I/O node comprises a network interface for providing an interface between the plurality of compute nodes and a network external to the server system.

3. The server system of claim 1, wherein the first I/O node comprises a storage interface for providing an interface between the plurality of compute nodes and a storage device.

4. The server system of claim 1, wherein the first I/O node is to communicate a second message received from the first compute node to a processing module of the first I/O node.

5. The server system of claim 1, further comprising:
a second input/output (I/O) node to send and receive data for the plurality of compute nodes and to route a second message received from a third compute node of the plurality of compute nodes to a fourth compute node of the plurality of compute nodes.

6. The server system of claim 5, wherein:
the fabric interconnect, plurality of compute nodes, and first and second I/O nodes form a 3-dimensional torus network topology; and
the first I/O node and the second I/O node are located at a same plane along a first dimension of the 3-dimensional torus.

7. The server system of claim 6, wherein the first I/O node and the second I/O node are offset from each other in a second dimension of the 3-dimensional torus.

8. The server system of claim 7, wherein the first I/O node and the second I/O node are offset from each other in a third dimension of the 3-dimensional torus.

9. The server system of claim 5, wherein the first I/O node comprises a network interface and the second I/O node comprises a storage device interface.

10. The server system of claim 1, further comprising a repeater node to route a second message received from a third compute node of the plurality of compute nodes to a fourth compute node of the plurality of compute nodes.

11. A server system, comprising:
a fabric interconnect to route messages;
a plurality of field replaceable units (FRUs) comprising compute nodes coupled to the fabric interconnect to execute services for the server system, each of the plurality of compute nodes to route received messages to others of the plurality of compute nodes; and
a first FRU comprising a repeater node coupled to the fabric interconnect to route a first message received from a first compute node of the plurality of compute nodes to a second compute node of the plurality of compute nodes.

12. The server system of claim 11, further comprising:
a second FRU comprising a first I/O node coupled to the fabric interconnect to send and receive data for the plurality of compute nodes and to route a second message received from a third compute node of the plurality of compute nodes to a fourth compute node of the plurality of compute nodes.

13. The server system of claim 12, wherein the first I/O node comprises a storage interface for providing an interface between the plurality of compute nodes and a storage device.

14. The server system of claim 12, wherein the first I/O node comprises a network interface for providing an interface between the plurality of compute nodes and a network external to the server system.

15. The server system of claim 12, wherein the first I/O node is to communicate the second message received from the first compute node to a processing module of the first I/O node.

16. The server system of claim 12, further comprising:
a third FRU comprising a second input/output (I/O) node to send and receive data for the plurality of compute nodes and to route a third message received from a fifth compute node of the plurality of compute nodes to a sixth compute node of the plurality of compute nodes.

17. A method, comprising:
receiving, from a first compute node, a message at an input/output (I/O) node of server system having a plurality of compute nodes coupled via a fabric interconnect; and
in response to the message being targeted to a second compute node of the server system, routing the message from the I/O node to the second compute node.

18. The method of claim 17, wherein the I/O node comprises a network interface for providing an interface between the plurality of compute nodes and a network external to the server system.

19. The method of claim 17, wherein the I/O node comprises a storage interface for providing an interface between the plurality of compute nodes and a storage device.

20. The method of claim 17, further comprising:
in response to the message being targeted to the I/O node, processing the message at a processing module of the I/O node.
